(19) United States
(12) Patent Application Publication
(10) Pub. No.: US 2005/0073582 A1
(43) Pub. Date: Apr. 7, 2005

(54) Device for improving the visibility conditions in a motor vehicle

(76) Inventors: Joerg Moisel, Neu-Ulm (DE); Michael Holz, Senden (DE)

Correspondence Address: PENDORF & CUTLIFF, 5111 Memorial Highway, Tampa, FL, 33634-7356, US

(21) Appl. No.: 10/957,846

(22) Filed: Oct. 4, 2004

(30) Foreign Application Priority Data
Oct. 2, 2003 (DE) 103 46 484.0-34

(51) Int. Cl. H04N 7/18

(52) U.S. Cl. 348/148; 348/164; 340/425.5

(57) ABSTRACT

The invention relates to a device for improving the visibility conditions in a motor vehicle, having a radiation source for infrared radiation for irradiating the surroundings of the vehicle, having an infrared-sensitive camera for taking images of at least part of the irradiated surroundings, having a display unit for displaying collected image data, and having a control unit for controlling the device. An image evaluation unit is also provided, which is connected to the camera and the control unit and which evaluates the collected image data with respect to the recommended velocity V_{richt} and makes it available to a vehicle driver as a velocity recommendation.

In addition the recommended maximum velocity Vₘₐₓ is optionally evaluated from the image data. A velocity sensor is provided, which is connected to the control unit in such a way that the control unit causes the display to be switched off when the vehicle velocity V exceeds the maximum velocity Vₘₐₓ. This device ensures that the vehicle with the device operates in a very safe way for the user.

### BACKGROUND OF THE INVENTION

1. Field of Invention

the invention relates to a device for improving the visibility in a motor vehicle.

2. Related Art of the Invention

DE 40 32 927 C2 discloses a device for improving the visibility in a motor vehicle having a radiation source for infrared radiation for irradiating the surroundings of the vehicle, and having an infrared-sensitive camera which takes images of the irradiated field of vision of the driver and makes available the collected image data to the driver by means of a display device which is embodied as a head-up display and in which the image data is visually superimposed as a visual image on the external landscape. By means of this device, the driver can see considerably better at night or under bad weather conditions, in particular when he is dazzled by oncoming vehicles. As a result of the use of infrared radiation, the driver is, in contrast, not dazzled by the oncoming traffic. Such devices are also referred to as night vision systems.

As a result of the improved visibility, the vehicle driver can be encouraged to look only at the display and to no longer observe the surroundings directly, which can lead to misinterpretations. In particular there is the risk of the field of vision being overestimated and the vehicle being driven too fast owing to the assumed better visibility.

### SUMMARY OF THE INVENTION

The invention is based on the object of specifying a device for improving the visibility conditions in a motor vehicle which reduces these disadvantages and as a result increases road safety.

This object is achieved by means of a device for improving the visibility conditions in a motor vehicle having the features of claim 1.

Advantageous developments of the invention are the subject matter of the subclaims.

The device according to the invention for improving the visibility conditions in a motor vehicle is not only provided with the radiation source for infrared radiation, the infrared-sensitive camera, the display for displaying the image data which is collected by means of the camera and the control unit for controlling the device but also with an image evaluation unit which is connected to the camera and to the control unit and which evaluates the collected image data. The evaluation by means of the evaluation image unit is carried out in such a way that, on the basis of the collected image data, a recommended velocity V_{richt} and, if appropriate, in addition a recommended maximum velocity Vₘₐₓ are determined.

In this context, the recommended velocity V_{richt} represents a velocity which is determined by means of the device and which ensures an efficient flow of traffic and also appropriate, vehicle-specific safety. In contrast, the recommended maximum velocity Vₘₐₓ represents a velocity which is determined by means of the device and which only ensures appropriate vehicle-specific safety. The legally prescribed maximum permissible velocity is to be distinguished from this recommended velocity V_{richt} and recommended maximum velocity Vₘₐₓ. This velocity is usually higher than the recommended maximum velocity Vₘₐₓ and this is in turn higher than the recommended velocity V_{richt}.

The specific recommended velocity V_{richt} is available to the vehicle driver, in particular by means of the display or alternatively or additionally by means of a voice output so that the driver receives a velocity recommendation which, on the one hand, ensures an efficient flow of traffic accompanied by sufficient road safety. Experience has shown that this velocity recommendation influences the driving behavior of the vehicle driver and as a result causes the vehicle to be driven better, in particular more safely, in traffic. This is associated with an improvement in the traffic flow and thus with a reduction in the stress of driving, which leads to a reduction in the incorrect behavior of a vehicle driver and thus to a reduction in traffic accidents.

In addition to the possibility of using the image evaluation unit for respectively determining both the recommended velocity V_{richt} and the recommended maximum vehicle velocity Vₘₐₓ from the image data, it has proven effective to determine the recommended maximum vehicle velocity Vₘₐₓ from the recommended velocity V_{richt}. It has proven particularly effective here to determine the recommended maximum vehicle velocity Vₘₐₓ by multiplying the recommended velocity V_{richt} by a predefined factor. A factor in the vicinity of 1.1 has proven particularly advantageous here. However, a factor in the vicinity of 1.05 or 1.2 satisfactorily fulfills the requirements which are made of a determination of the recommended maximum vehicle velocity Vₘₐₓ. This form for determining the recommended maximum vehicle velocity Vₘₐₓ proves very simple, fast, low in computing requirements and at the same time also sufficiently reliable. The factor is preferably selected in an adjustable fashion here so that said factor can easily be adapted to the driving behavior or the changed vehicle by the user himself or within the scope of a visit to a workshop.

A current velocity signal relating to the vehicle velocity V is advantageously also fed to the control unit by a velocity sensor which is connected to the device. The device is then controlled by the control unit as a function of the current vehicle velocity V in such a way that the collected image data is displayed on the display only when the vehicle velocity V drops below the recommended maximum velocity Vₘₐₓ. This ensures that the vehicle driver will not rely on the subjective impression of a particularly good, overestimated level of visibility owing to the device and will correspondingly make an inappropriately high selection of his vehicle velocity V in accordance with his misinterpreted field of vision. The velocity-dependent switching off when the recommended maximum velocity Vₘₐₓ is exceeded ensures that the vehicle driver is forced to rely on the direct sensing of the surroundings of the vehicle, i.e. for example to rely on the usual sensing of the surroundings of the vehicle at night or when visibility is poor, and he cannot make use of the improved visibility by virtue of the arrangement, which can be made available to him via the display. This switching off thus forces him to consider his velocity in the usual way since the improved visibility is now no longer available to him and he correspondingly has to select his driving velocity in accordance with the actual visibility in the visible range of light, that is to say without support by infrared radiation, and must correspondingly select a reduced velocity. This leads to a situation in which the driver will then usually reduce his vehicle velocity on the basis of the poor visibility, which has a positive effect on the road safety.

In this context, the collected image data is evaluated by means of an image data evaluation unit with respect to its properties, for example the brightness or contrast values, and the recommended velocity V_{richt} or the recommended maximum velocity Vₘₐₓ is then determined by means of the control unit as a function of these properties. This is carried out either by means of a reference table in which a measure of the respective properties is related to a measure of the recommended velocity V_{richt} or the maximum recommended velocity Vₘₐₓ, or by means of an arithmetic, for example by means of a direct conversion rule which calculates a specific maximum recommended velocity Vₘₐₓ or the recommended velocity V_{richt} on the basis of the average brightness or the average contrast of the image data, for example. This determination of the recommended velocity V_{richt} or maximum velocity Vₘₐₓ as a function of current image data makes it possible to ensure very up-to-date behavior of the device or control behavior which is tailored to the current image data and thus to the current situation over the surroundings. This ensures that the suitable recommended velocity V_{richt} or maximum velocity Vₘₐₓ is selected as a function of the respective situation of the surroundings and thus the respective visibility conditions, and as a result the vehicle driver is reliably induced to no longer rely on the displaying of the image data on the display. As a result, it is possible to prevent the driver from relying only on the image data displayed on the display and to induce him at least to additionally take into account the surroundings by direct sensing. This leads to a marked improvement in the driving behavior and thus in the safety of the vehicle driver, of the vehicle, and also of the traffic as a whole.

It has also proven effective to evaluate the collected image data with respect to its displayed content in terms of the state of the surroundings, in particular with respect to the profile of the underlying surface, the state of the underlying surface, the state of the weather, the road signs which are present or the traffic volume, and to determine the recommended velocity V_{richt} or the maximum velocity Vₘₐₓ therefrom, in particular by means of a classifier. If, for example, the classifier assesses or evaluates the profile of the underlying surface as a bendy section of road or as a freeway, or assesses or evaluates a road sign at the edge of the road as a road sign which relates to velocity, the recommended velocity V_{richt} and/or the maximum recommended velocity Vₘₐₓ is selected in accordance with this evaluation. This selection is typically carried out by means of a reference table. For example, in the case of a bendy section of road a lower recommended velocity V_{richt} or maximum velocity Vₘₐₓ is selected than in the case of a straight profile or in the case of a freeway. Correspondingly, if velocity-limiting road signs are present these are detected and evaluated, for example, by means of a classifier and the maximum recommended velocity is thus determined and made the basis of the control by the control unit.

Correspondingly, it has proven effective to sense the underlying state of the carriageway by means of the image evaluation unit, and to select the recommended velocity V_{richt} or maximum velocity as a function of the state of the underlying surface. If, for example, a very poor state of the underlying surface is determined by means of the image evaluation unit, which state may come about, for example, owing to a covering of snow or ice or dampness and also as a result of uneven ground, a low recommended velocity V_{richt} or maximum velocity Vₘₐₓ is selected, whereas a high recommended velocity V_{richt} and/or recommended maximum vehicle velocity Vₘₐₓ is selected, in particular one which is near to or equal to the legally permissible maximum driving velocity, when the underlying surface is dry or uniformly smooth and the state of the underlying surface is thus good.

The image evaluation unit can also be used to determine the state of the weather, in particular the field of vision or else the presence of rain or snow or fog, and derive a measure of the maximum recommended velocities therefrom. This specific determination of the maximum velocity as a function of the surroundings makes it possible to switch the display off or on very reliably and safely in such a way that the improved visibility is made available to the vehicle driver by the device according to the invention in an appropriate velocity range, while the improved visibility is not made available to him at a velocity outside this appropriate velocity range, i.e. above the recommended maximum velocity Vₘₐₓ, which causes him to perceive the surroundings directly and induces him to check and consider the driving velocity and usually to reduce the driving velocity. Experience has shown that this leads to a significantly safer driving style.

Furthermore, it is possible, since the mode of operation of the device forces the driver to stop looking at the representation of the surroundings on the display, to reduce the risk of tending to overestimate the visibility conditions and thus the risk of driving too fast since the vehicle driver then cannot rely only on the improved visibility which is provided by the device according to the invention. Overall, these aspects lead to an improvement in the safety of the vehicle driver or the driver and thus also of the traffic as a whole and the persons involved in it.

The representation on the display is preferably switched on again as soon as the vehicle velocity V drops below a predefined velocity limit, which is preferably equal to the recommended maximum velocity Vₘₐₓ or in the vicinity thereof. This leads to a situation in which the improved visibility is usually available when the velocity is appropriate, whereas it is not available when the velocity is too high—that is to say above the recommended maximum velocity Vₘₐₓ—in accordance with the control behavior by means of the control unit. This leads to markedly improved road safety.

It has proven particularly advantageous to develop the device according to the invention in such a way that the display is switched on when the vehicle velocity V drops below the maximum velocity Vₘₐₓ by the velocity difference V₀ in the range of a few kilometers per hour. As a result of this “delayed” switching on of the representation on the display it is possible to implement a switching behavior in the manner of a hysteresis, which can prevent unpleasant switching to and fro or a type of flickering of the display, as a result of the switching off which is controlled by the control unit when the maximum velocity Vₘₐₓ is exceeded, and the switching on when the vehicle velocity V drops below the maximum velocity Vₘₐₓ. This can preferably be carried out by selecting the velocity difference V₀ in the vicinity of several kilometers per hour, preferably in the vicinity of several percent in particular 5% of the evaluated recommended velocity V_{richt} or maximum velocity Vₘₐₓ. A predefined velocity difference V₀ in the vicinity of several kilometers per hour ensures very simple and safe control of the device, which can be implemented very easily and cost-effectively. Logically linking the velocity difference V₀ to the recommended velocity V_{richt} or the recommended maximum velocity Vₘₐₓ ensures dynamic control of the differentiated switching on and switching off process of the display or of the camera or of the radiation source in a way which is adapted to a situation, which gives rise to a very pleasant control behavior of the device. Such control which is adapted to the situation proves very pleasant for the vehicle driver, which has a very positive effect on his driving behavior and thus on the road safety.

It has proven particularly effective to embody the control device in such a way that the recommended velocity V_{richt} or the determined recommended maximum velocity Vₘₐₓ can be issued to the vehicle driver in particular via the display. This leads to a situation in which the vehicle driver receives information about the recommended velocity V_{richt} which is determined by means of the device according to the invention and/or recommended maximum velocity Vₘₐₓ and is thus inclined not to exceed these velocities and to drive safely below the maximum velocity or in the vicinity of the recommended velocity V_{richt}. This leads to a situation in which the improved visibility which is made available to him by the device according to the invention is always available and he is not unpleasantly surprised by switching off and is thus forced to drive only according to direct sensing or consideration of the surroundings.

According to another preferred embodiment of the invention, in addition to the on and off switches for the device, an additional switch for switching on the display, the radiation source and/or the camera of the device is provided. This additional switch permits active, conscious switching on of the representation of images on the display after the display, the radiation unit or the camera has previously been switched off. This ensures that the vehicle driver can completely activate the device as required by activating the additional switch and can thus obtain the advantage of the improved visibility. It has proven particularly effective here to implement the additional switch in the vicinity of the steering wheel, in particular in the form of a headlamp flasher switch or a rocker on the steering wheel. By arranging the additional switch in the vicinity of the steering wheel it is possible to activate the switch without the driver having to take one or both hands completely off the steering wheel. This leads to very safe handling of the device and thus to an increase in road safety. It has proven particularly effective to use the headlamp flasher switch as an additional switch for the device, ensuring that by actuating the headlamp flasher switch not only the headlamp flasher but also the display or the camera is actuated again. This leads to a situation in which images of at least part of the surroundings of the vehicle which are irradiated by the infrared radiation source are taken by the camera and the collected image data can be displayed on the display.

It has proven particularly advantageous to make the switching off of the display, that is to say the termination of the representation of the images, sudden, that is to say abrupt. This has the advantage that a control of the device which is simple and not very susceptible to faults is sufficient to bring about this positive effect according to the invention for increasing the road safety.

Furthermore, according to another embodiment of the invention it has proven effective to make the switching off process gradual so that the reproduction of images does not change abruptly but rather gradually, over a certain time period, from the complete representation of image data to the switched off state without representation of data. In this context, this gradual switching off can be brought about, in particular, by restricting the brightness values or contrast values of the representation of images or of the display in such a way that an increasingly low brightness range or contrast range is continuously made available. This reduction of the brightness range or contrast range is continued until these ranges have dropped to zero and the display is thus switched off. Alternatively, it has also proven effective to dissociate the image data by means of artificial noise and to make the dissociation become stronger and stronger, which is brought about by increasing the proportion of noise until the image data can virtually no longer be perceived. This state corresponds to the switched off display since this display is no longer suitable for displaying the image data to be displayed which relates to the sensed surroundings which have been irradiated by infrared light. This switching off process is preferably implemented as a linearly extending gradual transition, which is made possible by means of a control which is not too complicated. Alternatively, nonlinear processes are also conceivable. This embodiment of the device according to the invention with a gradual switching off process ensures that the user receives information about the imminent final termination of the representation of images before the final switching off of the representation of images on the display, and is thus not unpleasantly surprised. This has a positive effect on the reduction of the risk of accidents.

It has also proven particularly effective to signal the switching off to the vehicle driver before the switching off is carried out. This early signaling is triggered in particular when a velocity just below the recommended maximum velocity, in particular in a range above the recommended velocity V_{richt}, is reached. This signaling is carried out, for example, by means of a visual representation on the display, alternatively or additionally by means of haptic signaling, for example by vibrating the steering wheel or by means of an audible signal, for example by the sounding of a short tone. This advance information before the switching off is carried out ensures that the vehicle driver is prewarned to a particular degree before the switching off is carried out. This leads to an improvement in road safety. Audible warning signals have proven particularly effective since they can also be perceived without visual contact with the display, for example during the direct consideration of the surroundings of the vehicle and can thus be perceived by the vehicle driver in the usual way without interruptions or with only short interruptions in such a way that he is not surprised by the switching off of the display or the representation of images on the display. Alternatively or additionally to this signaling as a prewarning, a warning signal is preferably issued by a signal transmitter as soon as the recommended maximum velocity is exceeded. This warning signal is implemented, for example, by means of a visual representation on the display, alternatively or additionally by a haptic warning signal, for example by vibrating the steering wheel or by an audible warning signal, for example by the sounding of a short warning tone. In this context, the warning signal is typically selected to be differentiated from the signal for the early signaling of imminent switching off.

According to one preferred embodiment of the device, the control unit is embodied in such a way that, in addition to the display, the camera and/or the irradiation source can be switched off. In this context, the camera is switched off with the display or a short time after it. It is thus possible, during operation of the display, for the camera to always be operational and able to supply image data which can be displayed on the display. Alternatively or additionally to the camera, the radiation source is always switched on and off under the control of the control unit. This ensures that very efficient and safe operation of the device is ensured without restricting the operational capability of the device. This also ensures that the camera or the radiation source is not switched off too early, and thus either with the display or directly after it or only much later, since they consume a large amount of energy and can be operated again only very slowly. This has a positive effect on the consumption of energy of the device, which markedly improves the applicability of the device.

### BRIEF DESCRIPTION OF THE DRAWING

The invention will be explained in more detail below with reference to an exemplary implementation of the device according to the invention for improving the visibility conditions in a motor vehicle. The invention is not restricted to this embodiment.

FIG. 1 shows a schematic design of the device according to the invention for improving the visibility conditions in a motor vehicle.

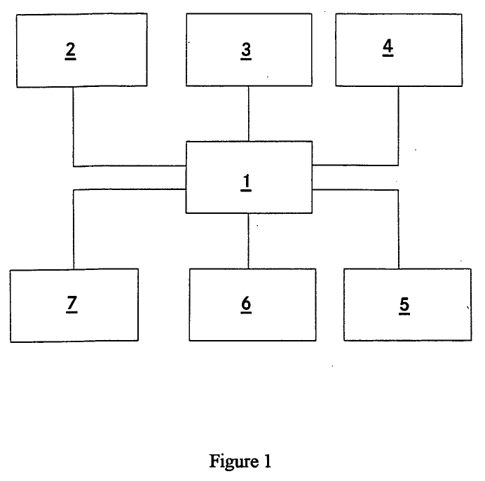

### DETAILED DESCRIPTION OF THE INVENTION

This device exhibits a radiation source 2 for infrared radiation which irradiates infrared radiation with a wavelength of approximately 800 nm. The radiation source 2 is implemented as an infrared laser. This radiation source 2 is arranged in the front region of the vehicle in the vicinity of the headlights and irradiates the region in front of the vehicle. In addition, this device has an infrared-sensitive camera 3 which is arranged in the vehicle and is orientated in such a way that it senses at least part of the surroundings which are irradiated by the infrared radiation source 2, and feeds the sensed image data to the display 4 via the control unit 1. By means of the display 4, the image data which is fed to it and sensed by the camera 3 is displayed and thus made available to a vehicle driver. The control unit 1 controls the infrared radiation source 2, the camera 3 and the display 4 in this context.

The infrared radiation source 2 radiates infrared radiation here, which is reflected at least partially from the surroundings and sensed by the infrared-sensitive camera 3 as reflected radiation and converts it into image data. This image data is represented by the display 4 either directly or after a certain degree of image signal processing by means of the image evaluation unit 6. As a result, the image which is represented on the display 4 is an infrared representation of the surroundings of the vehicle. Since the infrared reflective properties and irradiation properties of the surroundings differ from the properties in the visible light range, the image represented will also differ from the direct view of the surroundings by the vehicle driver. By using the device it is possible to use these differences advantageously, which leads to improved visibility in particular at night, but also in bad weather conditions such as in the rain or in fog.

The control unit 1 controls the display 4 here as a function of the sensed image data in such a way that the reproduction of images is switched on or off in a selective fashion. This is carried out in such a way that when the vehicle velocity V exceeds the maximum velocity Vₘₐₓ, the display is switched off, and switched on when it drops below said maximum velocity Vₘₐₓ. In this context, a velocity sensor 7 is provided which is connected to the control unit and passes on the vehicle velocity V to the control unit 1. Furthermore, a sensing unit 6 is provided which is connected to the camera and to the control unit and which determines the sensed recommended maximum velocity Vₘₐₓ and feeds it to the control unit 1. The control units controls the display with this information.

The collected image data is evaluated here by means of an image data evaluation unit 6 with respect to its properties, for example the brightness values and contrast values and the maximum velocity Vₘₐₓ is then determined, and the display 4 is subsequently switched on or off by means of the control unit 1 as a function of these properties. The switching on or off is carried out, for example, by means of a reference table in which a measure of the respective properties is contained related to the maximum velocity Vₘₐₓ or to the recommended velocity V_{richt}. As a result of this embodiment of the device it is possible to ensure a very current behavior of the device or control behavior which is tailored to the current image data and thus to the current situation of the surroundings in order to determine, in particular, the maximum velocity Vₘₐₓ. This ensures that appropriate switching on and switching off times are selected as a function of the respective situation of the surroundings and thus of the respective visibility conditions, and the vehicle driver is thus reliably induced not to rely too much on the representation of the image data on the display 4. As a result, it is possible to prevent the driver from taking into account only the image data displayed on the display 4 and to induce him at least to additionally take into account the direct surroundings. The representation of the recommended velocity V_{richt} which is determined also ensures that the vehicle driver is continuously informed about a recommended velocity V_{richt} which is optimized with respect to the traffic flow and the road safety. This leads to a considerable improvement in the driving behavior and thus the safety of the vehicle driver, of the vehicle and also of the traffic as a whole.

It is not necessary to completely switch off the display 4, it is sufficient for the operational capability of the device according to the invention to merely terminate the representation of images. The switching off of the display 4 requires the vehicle driver to look away from the display 4 and to direct his gaze directly onto the surroundings of the vehicle again. This ensures that he cannot be dazzled by the improved visibility which is provided by the device according to the invention and, owing to the improved visibility, misinterprets his own capabilities, the vehicle or the external circumstances and, for example, drives too quickly or with an inappropriate velocity. Instead, the switching off of the display 4 causes him to turn his attention directly to the surroundings of the vehicle and to adapt his driving behavior in the usual way to the visibility conditions which are then available to him and to use again the improved visibility after the device or the representation of images on the display 4 have been switched on again, without automatically being subject to a misinterpretation of the situation. This effect has proven very advantageous and very acceptable.

In addition to the switching off of the display 4 when the maximum velocity Vₘₐₓ is exceeded, the control unit 1 also has the control function of switching off the camera 3 in a corresponding way, that is to say simultaneously or shortly afterwards. This additional control function ensures very effective operation of the device, in which case, on the one hand, the operational capability of the device is maintained without restriction but, on the one hand, the consumption of energy of the device is markedly reduced. The consumption of energy of such a device is of particular significance in a vehicle since such a vehicle has a large number of electronic components of which a large number operate simultaneously, correspondingly consuming a considerable amount of energy which the vehicle, with its autonomous energy supply, can make available only to a limited degree.

Furthermore, the control unit 1 is connected to the headlamp flasher 5 which is arranged as an additional switch in the vicinity of the steering wheel. The actuation of the headlamp flasher causes the display 4 or the camera 3 to be actuated again and switched on again under the control of the control unit 1. After this, the display 4 and the camera 3 is kept operational until the display 4 and the camera 3 are switched off as a function of the recommended maximum velocity being exceeded. As a result of this simple embodiment of an additional switch for switching on the display 4 or the camera 3, a very robust and safe and easy-to-handle device is provided which, on the one hand, makes available improved visibility for the vehicle driver, and on the other hand prevents undesired driving only in accordance with the display, and on the other hand permits actuation without significant difficulties. By using the headlamp flasher switch 5 it is possible for the driver to activate the display 4 or the camera 3 by actuating the headlamp flasher in parallel, without the driver having to release the steering wheel from his secure grip. This leads to very safe handling of the device and thus to an increase in road safety.

The control unit 1 is connected to an image evaluation unit 6 which carries out the termination of the representation of images, and thus the switching off of the display 4, in a gradual fashion. In this context, the sensed image data is artificially degraded during the gradual switching off by adding noise components until only noise is represented on the display 4, and the display 4 can thus be switched off, as it were. As the noise increases, the detectable image information, and thus the represented image data becomes less useful for the vehicle driver, who is accordingly increasingly inclined to view and sense the surroundings of the vehicle directly. This gradual switching off ensures that the vehicle driver is prewarned about the imminent, final switching off and is thus not surprised by the final switching off. The recommended velocity V_{richt} is always issued to the vehicle driver on the display independently of the degree of gradual switching off. Even after the display has been “switched off”, that is to say after the state in which the sensed image information about the vehicle surroundings is not displayed, the current or the one determined last recommended velocity V_{richt} is preferably represented. This has proven very positive for the vehicle driver.

The described device thus exhibits switching off of individual components 3, 4 as a function of the velocity V at which the vehicle is traveling. This embodiment of the device makes it possible to limit incorrect preconceptions of the vehicle driver with respect to the driving situation and thus to increase the road safety for the vehicle driver, the vehicle and the traffic as a whole.

1. A device for improving the visibility conditions in a motor vehicle, having
a radiation source for infrared radiation for irradiating the surroundings of the vehicle,
an infrared-sensitive camera for taking images of at least part of the irradiated surroundings,
a display unit for displaying collected image data,
a control unit for controlling the device, and
an image evaluation unit connected to the camera and to the control unit, which evaluates the collected image data with respect to a recommended velocity V_{richt} and makes it available to a vehicle driver as a velocity recommendation.

2. The device for improving the visibility conditions in a motor vehicle as claimed in claim 1, wherein the image evaluation unit additionally evaluates the collected image data with respect to a recommended maximum velocity Vₘₐₓ, wherein a velocity sensor is provided which is connected to the control unit, and wherein the control unit is embodied in such a way that the display is switched off when a vehicle velocity V exceeds the maximum velocity Vₘₐₓ.

3. The device for improving the visibility conditions in a motor vehicle as claimed in claim 2, wherein the control unit is embodied in such a way that the display is switched on when a vehicle velocity V drops below the maximum velocity Vₘₐₓ.

4. The device for improving the visibility conditions in a motor vehicle as claimed in claim 1, wherein the control unit is embodied in such a way that the display is switched on when a vehicle velocity V drops below the maximum velocity Vₘₐₓ by the velocity difference V₀.

5. The device for improving the visibility conditions in a motor vehicle as claimed in claim 4, wherein the velocity difference V₀ is selected in the region of a few percent of the maximum velocity Vₘₐₓ, in particular in the region of 5% thereof.

6. The device for improving the visibility conditions in a motor vehicle as claimed in claim 1, wherein a sensing unit or the image evaluation unit is provided, said unit evaluating the state of the surroundings, in particular the position, the profile of the underlying surface, the state of the underlying surface, the state of the weather, the road signs which are present or the volume of traffic in such a way that the recommended velocity V_{richt} and/or the maximum velocity Vₘₐₓ are determined as a function thereof.

7. The device for improving the visibility conditions in a motor vehicle as claimed in claim 1, wherein the control unit is embodied in such a way that the recommended velocity V_{richt} and/or the maximum velocity Vₘₐₓ can be displayed on the display.

8. The device for improving the visibility conditions in a motor vehicle as claimed in claim 2 wherein, in addition to an on/off switch for the device, an additional switch for switching on the display after switching off has been carried out is provided.

9. The device for improving the visibility conditions in a motor vehicle as claimed in claim 8, wherein the additional switch is implemented in the vicinity of the steering wheel, in particular by means of a headlamp flasher switch or a steering wheel rocker.

10. The device for improving the visibility conditions in a motor vehicle as claimed in claim 2, wherein the display is switched off suddenly.

11. The device for improving the visibility conditions in a motor vehicle as claimed in claim 2, wherein the display is switched off gradually.

12. The device for improving the visibility conditions in a motor vehicle as claimed in claim 2, wherein a signal transmitter is provided which is connected to the control unit and which is actuated in such a way that, before or as the vehicle velocity V exceeds the recommended velocity V_{richt} and/or the maximum velocity Vₘₐₓ, a visual, audible and/or haptic warning signal is issued.

13. The device for improving the visibility conditions in a motor vehicle as claimed in claim 1, wherein the control unit is embodied in such a way that, in addition to the display, the camera and/or the radiation source can also be switched off and on as a function of the velocity.
